(19) United States
(12) Patent Application Publication
(10) Pub. No.: US 2015/0210332 A1
(43) Pub. Date: Jul. 30, 2015

(54) Bicycle support stand

(71) Applicants: Reginald Scott Jensen, Granite Bay, CA (US); Thomas Cornwall Jensen, Pleasanton, CA (US)

(72) Inventors: Reginald Scott Jensen, Granite Bay, CA (US); Thomas Cornwall Jensen, Pleasanton, CA (US)

(21) Appl. No.: 13/999,230

(22) Filed: Jan. 30, 2014

(51) Int. Cl. B62H 1/06

(52) U.S. Cl. CPC B62H 1/06

(57) ABSTRACT

A support stand for holding a bicycle or other two wheeled vehicle in a generally upright position by means of a linear member which can be easily and quickly removed and stored. The support stand is designed to accommodate two wheeled vehicles having frame geometries or materials that cannot incorporate other conventional stands or where vehicle weight is a critical factor.

### FIELD OF THE INVENTION

The present invention relates to a bicycle or similar two wheeled vehicle support stand that supports the bike or vehicle in a generally upright position comprising a generally linear member that is easily and quickly removed. The present invention is specifically important for bicycles where frame geometries or materials cannot incorporate conventional stands or where weight is a critical factor.

### BACKGROUND OF THE INVENTION

In recent years, bicycles have evolved into light-weight, high-tech machines for various types of racing and general recreational use. The use of exotic materials such as carbon fiber, Kevlar and light weight metal alloys for bicycle components has created road and mountain bikes that are much stronger and lighter resulting in much faster speeds or less mechanical effort for the rider. The use of exotic metals alloys and composite fiber bike frames has resulted in frame geometries that will not accommodate traditional “kick stands”. U.S. Pat. Nos. 3,425,713 and 3,652,105 are examples of these types of support stands. Said support stands are permanently attached to frame members adjacent to the crank by means of a nut and bolt. Attaching “kick stands” to composite frames by this manner causes stress fractures and frame failure. In addition, most modern frame geometries will not accommodate this type of “kick stand”.

To keep today's high performance bikes light weight, bike stands commonly referred to as “kick stands” have been eliminated. Light-weight bikes equate to faster speeds and higher performance. The elimination of “kick stands” has created a problem for modern bike storage. Bikes must be laid flat on the ground or propped against a vertical immovable object such as a wall or stored in a rack that traps the wheel. None of these are good options for the rider. Bikes laid on their side take up a larger space where space is limited and can be easily damaged. Public bike racks are in short supply and tend to mar paint. Bikes propped up against a tree or wall are prone to falling over. Additionally, marring the surfaces of the bike in contact with the support surface is problematic. To address these problems inventers have proposed several solutions.

Campau (U.S. Pat. No. 614,442) proposed a bike stand that trapped the crank and pedal in a vertical position with a linear member contacting the ground. Cook (U.S. Pat. No. 1,227,390) proposed a generally linear member with a hooked end that interlaced with old style frame members adjacent to the crank with the opposite end contacting the ground. Townsend (U.S. Pat. No. 3,712,637), Marchello (U.S. Pat. No. 3,980,320) and Coppel (U.S. Pat. No. 4,591,180) proposed bike stands similar to Cook but utilized different portions of the bike frame. All of these proposed inventions required specific frame geometries that are incompatible with today's bike frames.

The problems encountered by the above inventions are addressed by Blake (U.S. application Ser. No. 13/980,852). This patent application proposes the use of a metallic tab permanently mounted to the rear axle. A generally linear multi-section rod held together by an interior elastic member holds the sections together. One end of the linear rod slides into the metallic tab; the other end rests on the ground thus supporting the bike. Blake's proposed invention, though functional, has several disadvantages the present invention overcomes.
The elastic member used to hold the bike stand together can break rendering said stand useless.
The rear cam lock must be temporarily removed from the axle to properly install a metallic tab which communicates with the rest of the bike stand when in use.
When stored, multiple segments of the bike stand are pulled apart and folded into a bundle. Tension applied to the folded segments by the elastic member result in the bundle unfolding unless restrained by another elastic band applied axially to the folded segments.

### SUMMARY OF THE INVENTION

A support stand supporting a bicycle in a generally vertical position comprising a simple connecting and detachable means to the existing bicycle. The support stand consists of a pin of appropriate size and shape inserted into the pedal crank retaining mechanism. The other end of said pin is connected to a generally linear member of appropriate length and angle with the opposite end in contact with the ground.

### DESCRIPTION OF DRAWINGS

FIG. 1 is a planar view of the support stand supporting a bicycle.

FIG. 2 is an isometric view of an alternant embodiment of the present invention supporting a bicycle by attaching to the rear wheel axle.

### DETAILED DESCRIPTION OF THE PREFERRED EMBODIMENT

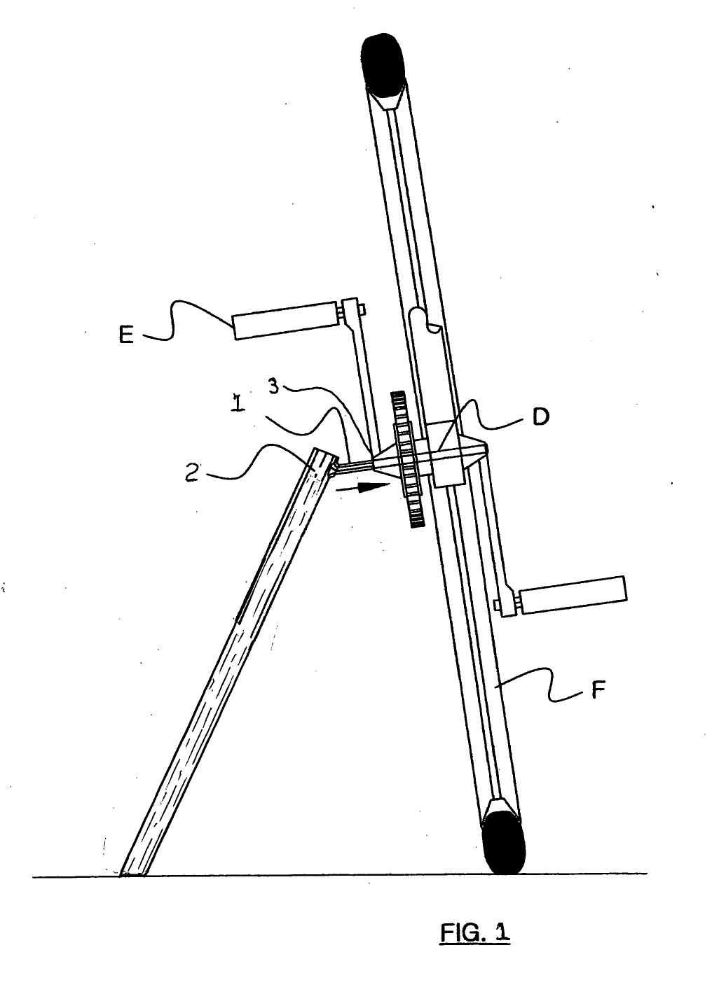

The present invention is a bicycle support stand as generally shown in FIG. 1. The support stand (FIG. 1) consists of a pin (1) of proper shape one end of which slides into the retaining mechanism (3) that securely attaches bicycle crank (E) to the main drive axle (D). Usually said retaining mechanism (3) is an Allen type bolt but other innovative designs are now being used by some high end bike manufactures. All of these designs incorporate an open aperture which will accommodate a pin (1) of proper size and shape. The other end of pin (1) is permanently attached to linear member (2) of proper length and angle to support the bike in a generally upright position.

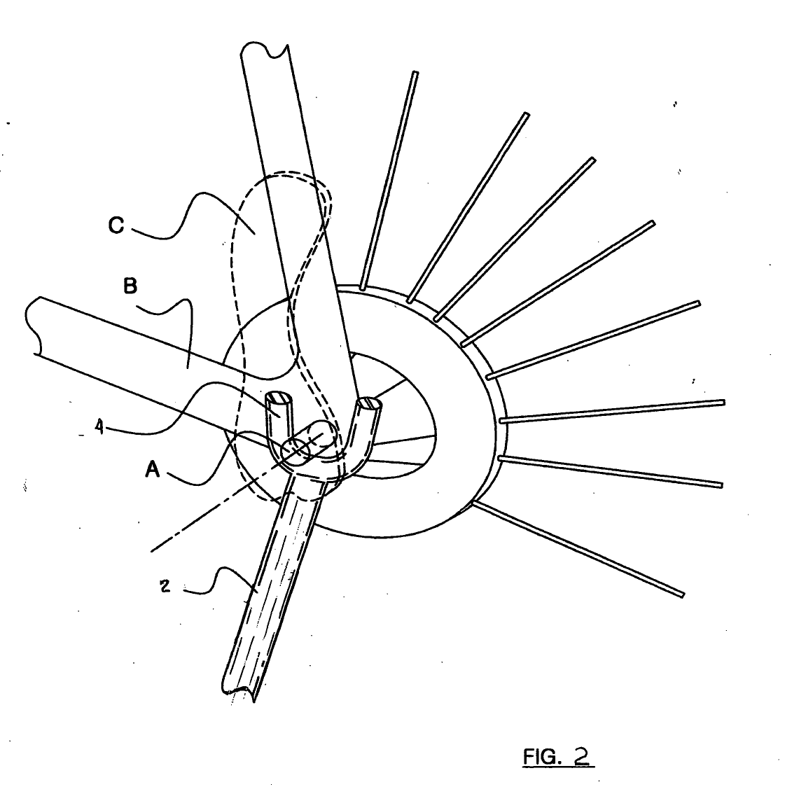

### Operation: FIGS. 1, 2

The present invention (FIG. 1) relates to a support stand for a bicycle consisting of pin (1) and linear member (2).

To operate the bicycle stand (FIG. 1) the rider removes said stand from his pocket or other preferred storage compartment. Pin (1) is inserted into the open aperture of retaining mechanism (3) and linear member (2) rotated until it contacts the ground. The bicycle is prevented from rolling by then turning the front wheel to an extreme angle relative to the frame.

The present invention also relates to an alternant method of supporting a bicycle as shown by FIG. 2. Pin (1) on support stand (FIG. 1) is removed and replaced by U shaped member (4). The operation of this embodiment is accomplished by inserting U shaped member (4) vertically between rear wheel cam axle lock (C) and bicycle frame (B). The rest of the operation of this alternate embodiment is the same as previously described.

### Advantages

From the description above, a number of advantages of the bicycle support stand become evident:
(a) No modification of the existing bicycle is required.
(b) The support stand is quickly and easily mounted to, or removed from, the bicycle.
(c) The support stand can be easily carried in a person's pocket.
(d) The support stand is light weight.

None of the prior art patents listed herein provide all of the above advantages of the present invention.

I claim:

1. A bicycle support stand comprising: a simple connecting means to the existing bicycle; a generally linear member comprising: an outer housing containing an inner extendable and retractable member with a ground support base.

2. The bicycle support stand as set forth in claim 1 where the support stand connects to the bicycle by a suitable pin that inserts into the crank bolt hole.

3. The bicycle support stand as set forth in claim 1 with the ability to extend the inner member to the required length and lock it securely in place.

4. The bicycle support stand as set forth in claim 3 where the inner member contains a measurement means to adjust the support stand length to fit various bicycle wheel diameters or frame sizes.

5. The bicycle stand as set forth in claim 1 where a ground support base is provided to add additional support and prevent the inner rod from sinking into the ground.

6. The bicycle support stand as set forth in claim 1 where inner member retracts into the outer housing.

7. A bicycle support stand comprising: a simple connecting means to the existing bicycle; a generally linear member comprising: an outer housing containing an inner extendable and retractable member.

8. The bicycle support stand as set forth in claim 7 where the support stand connects to the bicycle by a suitable pin that inserts into the crank bolt hole.

9. The bicycle support stand as set forth in claim 7 with the ability to extend the inner member to the required length and lock it securely in place.

10. The bicycle support stand as set forth in claim 9 where the inner member contains a measurement means to adjust the support stand length to fit various bicycle wheel diameters or frame sizes.

11. The bicycle support stand as set forth in claim 7 where the inner member retracts into the outer housing.

12. A bicycle support stand comprising: a support member that fits in the void between the rear axle cam lock and the bicycle frame; a generally linear member comprising an outer housing and an inner extendable and retractable member.

13. The bicycle support stand as set forth in claim 12 with the ability to extend the inner member to the required length and lock it securely in place.

14. The bicycle support stand as set forth in claim 12 where the inner member contains a measurement means to adjust the support stand length to fit various bicycle wheel diameters or frame sizes.

15. The bicycle support stand as set forth in claim 12 where the inner member retracts into the outer housing.
